(19) United States
(12) Patent Application Publication
(10) Pub. No.: US 2026/0133549 A1
(43) Pub. Date: May 14, 2026

(54) HUMAN RISK ASSESSMENT SYSTEM ACCORDING TO THE OCCURRENCE OF ENVIRONMENTAL HARMFUL FACTORS

(71) Applicant: Daegu Catholic University Industry Academic Cooperation Foundation, Gyeongsangbuk-do (KR)

(72) Inventor: Won Ho Yang, Daegu (KR)

(73) Assignee: Daegu Catholic University Industry Academic Cooperation Foundation, Gyeongsangbuk-do (KR)

(21) Appl. No.: 19/340,315

(22) Filed: Sep. 25, 2025

(30) Foreign Application Priority Data
Nov. 14, 2024 (KR) 10-2024-0162211

(51) Int. Cl. G05B 13/04

(52) U.S. Cl. CPC G05B 13/048

(57) ABSTRACT

A human risk assessment system for environmental harmful factors includes a communication unit configured to receive at least one of actual measurement data and monitoring data from the outside, and a controller configured to store information on multiple emission sources, emission amounts of hazardous substances from the emission sources, and an atmospheric dispersion model for the emission amounts. When at least one of actual measurement data or monitoring data on the emission amounts of hazardous substances from the emission sources is received from the communication unit, the controller calculates exposure concentrations of hazardous substances for receptors based on the atmospheric dispersion model and assesses the risks of hazardous substances from the emission sources using the calculated exposure concentrations.

### GOVERNMENT LICENSE STATEMENT

This invention was made with the support of the National Research and Development Project of the Republic of Korea (Project Unique Number: 2480000067; Project Number: RS-2021-KE002003), funded by the Ministry of Environment and managed by the Korea Environmental Industry & Technology Institute. The research was conducted under the program “Core Technology Development Project for the Prevention and Management of Environmental Diseases,” specifically the project entitled “Development of Source Tracking Technology for Emission Sources in Environmentally Vulnerable Areas,” performed by the DAEGU CATHOLIC UNIVERSITY INDUSTRY ACADEMIC COOPERATION FOUNDATION during the period from Jan. 1, 2024 to Dec. 31, 2024.

### CROSS-REFERENCE TO RELATED APPLICATIONS

This application claims the priority of Korean Patent Application No. 10-2024-0162211 filed on Nov. 14, 2024, in the Korean Intellectual Property Office, the disclosure of which is incorporated herein by reference.

### BACKGROUND

### Field

The present disclosure relates to a human risk assessment system according to occurrence of environmental harmful factors.

### Description of the Related Art

Currently, the atmosphere in certain areas is being polluted not only by changes in the natural environment, such as climate change, desertification, and yellow dust, but also by artificial fine dust generated from automobile exhaust and industrial emissions. The human respiratory system is directly exposed to fine dust through breathing, which is associated with respiratory diseases, such as coughing, asthma, and pneumonia. In particular, Seoul, South Korea, exhibits higher concentrations of fine dust compared to other major cities due to the influence of fine dust and yellow dust.

As is known, fine dust contains sulfur, nitrogen, carbon, and heavy metals, which may increase the likelihood of viral respiratory infections when inhaled, readily cause various lung diseases, and potentially induce neurological disorders by damaging neurotransmitters.

Currently, outdoor fine dust concentrations in South Korea can be obtained in real time by regions from the Korea Environment Corporation, the Korea Meteorological Administration, and other related institutions.

However, although forecasts on broadcasts or the Internet provide warning of hazardous conditions, the actual air quality at a given location may differ, creating the possibility of temporarily in inhaling high concentrations of fine dust. Therefore, there is a need for a more accurate means of providing notification of fine dust conditions.

However, in the related art, there is a problem in that it is not possible to accurately predict how hazardous substances emitted from multiple emission sources move and affect receptors.

### RELATED ART DOCUMENT

### Patent Document

(Patent Document 1) Korean Registered Patent No. 10-2414765 (System for monitoring noxious factor based on user location information)

### SUMMARY

An object of the present disclosure is to provide a human risk assessment system according to occurrence of environmental harmful factors, which assess risks of hazardous substances emitted from multiple emission sources using an atmospheric dispersion model.

In order to achieve the above-described objects, according to an aspect of the present disclosure, a human risk assessment system according to occurrence of environmental harmful factors includes a communication unit which receives at least one of actual measurement data and monitoring data from the outside; and a controller which stores multiple emission sources, a hazardous substance emission amount from the multiple emission sources, and an atmospheric dispersion model about the hazardous substance emission amount. When at least one of the actual measurement data and the monitoring data regarding the emission amounts of hazardous substances from multiple emission sources is received through the communication unit, the controller calculates exposure concentrations of the hazardous substances for receptors based on the atmospheric dispersion model, and assesses the risks of the hazardous substances from multiple emission sources based on the calculated exposure concentrations. After accurately calculating exposure concentrations of hazardous substances for receptors in various regions by applying actual measurement data and monitoring data to the atmospheric dispersion model, the risks of the hazardous substances are assessed, thereby enabling improvement of the emission sources and identification of risky situations for the receptors.

Here, when at least one of the actual measurement data and the monitoring data is not received from the communication unit, but the emission amount by company and industry type, among multiple emission sources, is received and the controller may predict concentrations of hazardous substances for multiple emission sources based on the reception result and the atmospheric dispersion model. Accordingly, even in the absence of actual measurement data, it is desirable that concentrations of hazardous substances can be predicted by identifying emissions by company and industry type.

Further, the controller calculates contribution levels for the various exposure targets based on the predicted concentrations of hazardous substances for multiple emission sources, so that, after accurately calculating the concentrations of hazardous substances for receptors in various regions, the risks of the hazardous substances can be assessed.

Here, the actual measurement data and the monitoring data include position information comprising a latitude and a longitude of the emission source, wind direction, wind speed, a distance parameter, and concentrations of hazardous substances of the emission source, so that the movement and dispersion of the hazardous substances can be accurately predicted.

In addition, the atmospheric dispersion model is expressed by the following equations so that the movement and dispersion of hazardous substances can be numerically represented, thereby enabling accurate calculation of concentrations of hazardous substances for exposure targets in various regions.

$$level = \frac{Q}{π {σ}_{y} , {σ}_{x} μ} exp [ - \frac{1}{2} {( \frac{H}{{σ}_{z}} )}^{2} ]$$

$$Q = pollution level of emission source ( unit : g / s )$$

$${σ}_{y} , {σ}_{z} = wind direction dispersion standard deviation of plume \\ μ = wind speed ( unit : m / s ) \\ H = effective chimney height ( unit : m ) \\ level = pollution level per grid$$

$${σ}_{y} = {a}_{y} \times {( \frac{x}{1000} )}^{{b}_{y}} \\ {σ}_{z} = {a}_{z} \times {( \frac{x}{1000} )}^{{b}_{z}}$$

$$x = distance between emission source and center of grid ( unit : m )$$

Here, the controller calculates grid information and concentrations of hazardous substances corresponding to the position information using the atmospheric dispersion model, and assesses risks of the hazardous substances from multiple emission sources based on population data associated with the calculated grid, so as to identify impacts on receptors in the corresponding region.

In addition, the human risk assessment system includes a display unit configured to display the assessed risks of hazardous substances. When the controller causes the display unit to display concentrations of hazardous substances in the calculated grid on a map, the concentrations of hazardous substances in the corresponding region can be identified at a glance.

According to the present disclosure, after accurately calculating concentrations of hazardous substances for receptors in various regions by applying actual measurement data and monitoring data to the atmospheric dispersion model, the risks of the hazardous substances are assessed, thereby enabling improvement of the emission sources and identification of risky situations for receptors.

Further, even though there is no actually measured data, it is possible to predict concentrations of hazardous substances by identifying emissions by company and industry type.

Further, after accurately calculating concentrations of hazardous substances for receptors in various regions, the risks of the hazardous substances are assessed.

Further, the movement and dispersion of hazardous substances can be predicted, and can be numerically represented to accurately calculate concentrations of hazardous substances for receptors in various regions.

Further, the impact on receptors in the corresponding region is identified, and the concentrations of hazardous substances in the corresponding region can be identified at a glance.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a control block diagram of a human risk assessment system according to occurrence of environmental harmful factors according to the present disclosure;

FIG. 2 is a flowchart of a first embodiment of a human risk assessment method according to occurrence of environmental harmful factors according to the present disclosure;

FIG. 3 is a flowchart of a second embodiment of a human risk assessment method according to occurrence of environmental harmful factors;

FIG. 4 is a flowchart of a third embodiment of a human risk assessment method according to occurrence of environmental harmful factors;

FIG. 5 is a view for an example of establishing a list of atmosphere pollutant sources and emissions;

FIG. 6 is an exemplary view of an atmospheric dispersion model;

FIG. 7 is an exemplary view of an exposure scenario;

FIG. 8 is a flowchart of exposure assessment; and

FIG. 9 is an exemplary view for calculating an atmospheric dispersion model, an existing population, and inhalation exposure assessment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, a human risk assessment system 1 according to occurrence of environmental harmful factors according to an exemplary embodiment of the present disclosure will be described in detail with reference to the accompanying drawings.

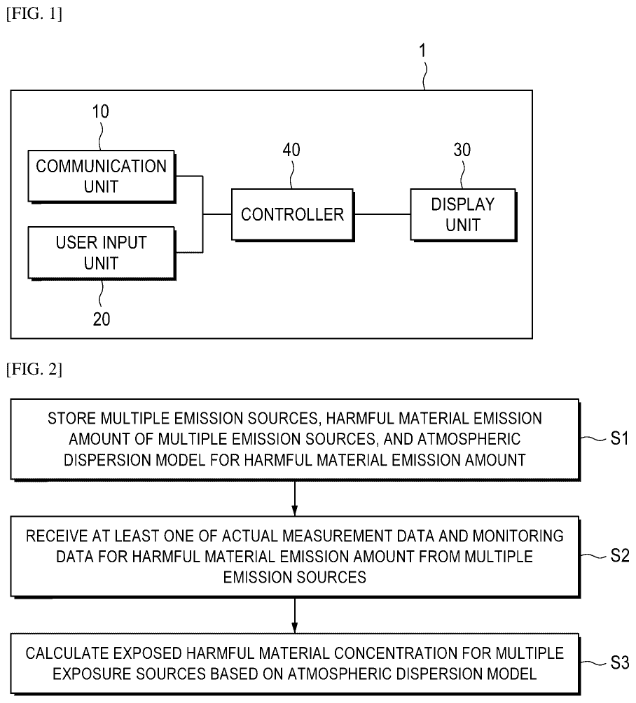

FIG. 1 is a control block diagram of a human risk assessment system 1 according to occurrence of environmental harmful factors according to the present disclosure.

The human risk assessment system 1 according to occurrence of environmental harmful factors includes a communication unit 10, a user input unit 20, a display unit 30, and a controller 40.

The communication unit 10 receives at least one of actual measurement data and monitoring data from the outside. The communication unit 10 performs wireless communication and the wireless communication includes at least one of IR communication, RF, Zigbee, and Bluetooth. The communication unit 10 receives an image signal to transmit the image signal to the controller 40 to be described below and may be implemented in various manners in response to a specification of the received image signal and an implementation type of a user terminal. For example, the communication unit 10 may receive a radio frequency (RF) signal transmitted from a broadcasting station (not illustrated) in a wireless manner or receives a composite video, a component video, super video, SCART, and an image signal according to a high definition multimedia interface (HDMI) specification in a wired manner. When the image signal is a broadcasting signal, the communication unit 10 may include a tuner which tunes the broadcasting signal by channels.

The user input unit 20 may be configured by an input unit which allows a user to input a user command. The user input unit 20 receives a user's touch input or a remote input of the user using a remote controller to transmit the touch input or the remote input to the controller 40. Further, the user input unit 20 receives a voice input spoken by the user to transmit the voice signal to the controller 40. In this case, for example, the user input unit 20 may be implemented by a microphone. The user input unit 20 may independently perform the signal processing for the received voice signal. However, a type of the user input which may be received by the user input unit 20 is not limited thereto, and for example, the user input through motion recognition may also be received.

The display unit 30 may display the assessed risks of hazardous substances. The display unit 30 displays an image based on the image signal processed by the image processing. The implementation method of the display unit 30 is not limited and for example, the display unit may be implemented by various display methods, such as liquid crystal, plasma, light-emitting diode, organic light-emitting diode, surface conduction electron-emitter, carbon nano-tube, or nano-crystal.

The display unit 30 may further include an additional configuration according to the implementation method. For example, when the display unit 30 is a liquid crystal type, the display unit 30 includes a liquid crystal display panel (not illustrated), a backlight unit (not illustrated) which supplies light, and a panel driving substrate (not illustrated) which operates a panel (not illustrated). The display unit 30 may include a voice recognition result as information about a recognized voice. Here, the voice recognition result may be implemented by various forms, such as texts, graphics, and icons and the texts include characters and numbers. The display unit 30 may further display candidate commands and application information according to a voice recognition result. The user may check whether a voice is correctly recognized by the voice recognition result displayed on the display unit 30 and selects a command corresponding to a voice spoken by the user, among the displayed candidate commands or selects information related to the voice recognition result by manipulating the user input unit 20 provided on the remote controller.

The controller 40 stores information on multiple emission sources, the emission amounts of hazardous substances from multiple emission sources, and an atmospheric dispersion model for the emission amounts of hazardous substances. When at least one of actual measurement data and monitoring data regarding the emission amounts of hazardous substances from multiple emission sources is received from the communication unit 10, the controller 40 calculates an exposure concentrations of the hazardous substances for receptors based on the atmospheric dispersion model and assesses the risks of the hazardous substances from multiple emission sources based on the calculated exposure concentrations.

When neither the actual measurement data nor the monitoring data is received from the communication unit 10, but emission amounts classified by company and industry type, among multiple emission sources, are received, the controller 40 may predict concentrations of hazardous substances for multiple emission sources based on the received data and the atmospheric dispersion model.

The controller 40 may calculate contribution levels for the receptors based on the predicted concentrations of hazardous substances from multiple emission sources.

The controller 40 calculates grid information and corresponding concentrations of hazardous substances using the atmospheric dispersion model, and may assess the risks of the hazardous substances from multiple emission sources based on the population associated with the calculated grid.

The controller 40 may control the display unit 30 to display concentrations of hazardous substances for the calculated grid on a map.

The actual measurement data and the monitoring data may include position information such as latitude and longitude of the emission source, wind direction, wind speed, distance scale, and concentrations of hazardous substances from the emission source.

The atmospheric dispersion model is formed by the following Equation.

$$level = \frac{Q}{π {σ}_{y} , {σ}_{x} μ} exp [ - \frac{1}{2} {( \frac{H}{{σ}_{z}} )}^{2} ] \\ Q = pollution level of emission source ( unit : g / s )$$

$${σ}_{y} , {σ}_{z} = wind direction dispersion standard deviation of plume \\ μ = wind speed ( unit : m / s ) \\ H = effective chimney height ( unit : m ) \\ level = pollution level per grid$$

$${σ}_{y} = {a}_{y} \times {( \frac{x}{1000} )}^{{b}_{y}} \\ {σ}_{z} = {a}_{z} \times {( \frac{x}{1000} )}^{{b}_{z}} \\ x = distance between emission source and center of grid ( unit : m )$$

FIG. 2 is a flowchart of a first embodiment of a human risk assessment method according to occurrence of environmental harmful factors according to the present disclosure.

Multiple emission sources, emission amounts of hazardous substances from multiple emission sources, and an atmospheric dispersion model for the emission amounts of the hazardous substances are stored in step S1.

At least one of actual measurement data and monitoring data regarding the emission amounts of hazardous substances from multiple emission sources is received in step S2.

An exposure concentrations of hazardous substances for receptors are calculated based on the atmospheric dispersion model in step S3.

The risks of the hazardous substances from multiple emission sources are assessed based on the calculated exposure concentrations of the hazardous substances in step S4.

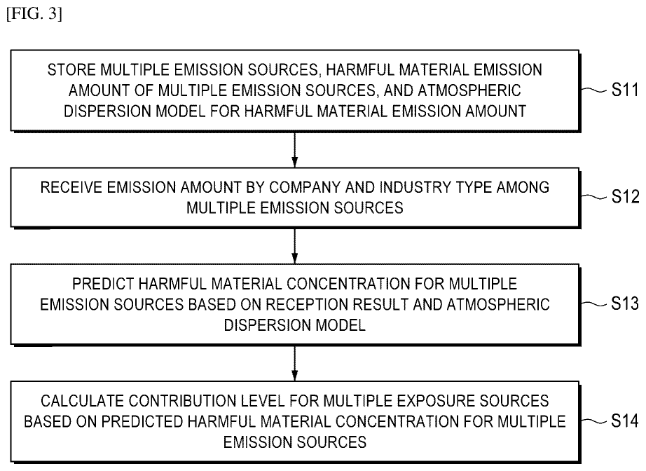

FIG. 3 is a flowchart of a second embodiment of a human risk assessment method according to occurrence of environmental harmful factors.

Multiple emission sources, emission amounts of hazardous substances from multiple emission sources, and an atmospheric dispersion model for the emission amounts of the hazardous substances are stored in step S11.

An emission amount by company and industry type, among multiple emission sources, is received in step S12.

A concentrations of hazardous substances from multiple emission sources are predicted based on the received data and the atmospheric dispersion model in step S13.

A contribution level for receptors are calculated based on the predicted concentrations of hazardous substances from multiple emission sources in step S14.

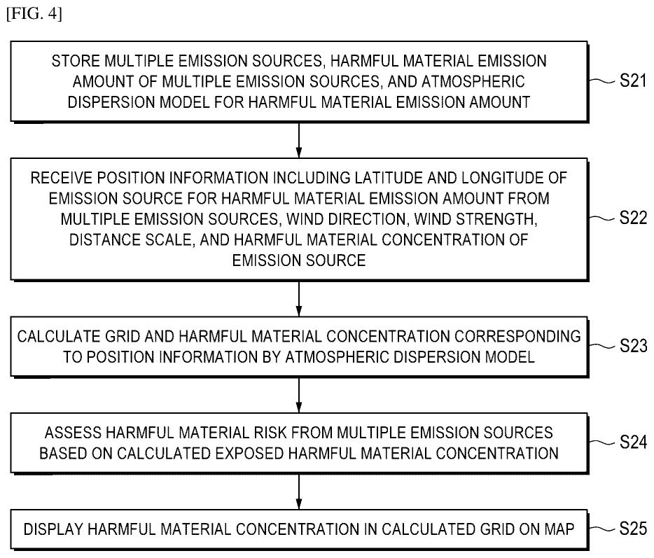

FIG. 4 is a flowchart of a second embodiment of a human risk assessment method according to occurrence of environmental harmful factors.

Multiple emission sources, emission amounts of hazardous substances from multiple emission sources, and an atmospheric dispersion model for the emission amounts of the hazardous substances are stored in step S21.

Position information such as latitude and longitude of the emission sources, emission amounts of hazardous substances from multiple emission sources, a wind direction, a wind speed, a distance scale, and concentrations of hazardous substances from the emission source are received in step S22.

A grid information and corresponding concentrations of hazardous substances are calculated using the atmospheric dispersion model based on the position information in step S23.

The risks of the hazardous substances from multiple emission sources are assessed based on the calculated exposure concentrations of the hazardous substances in step S24.

The concentrations of hazardous substances for the calculated grid are displayed on a map in step S25.

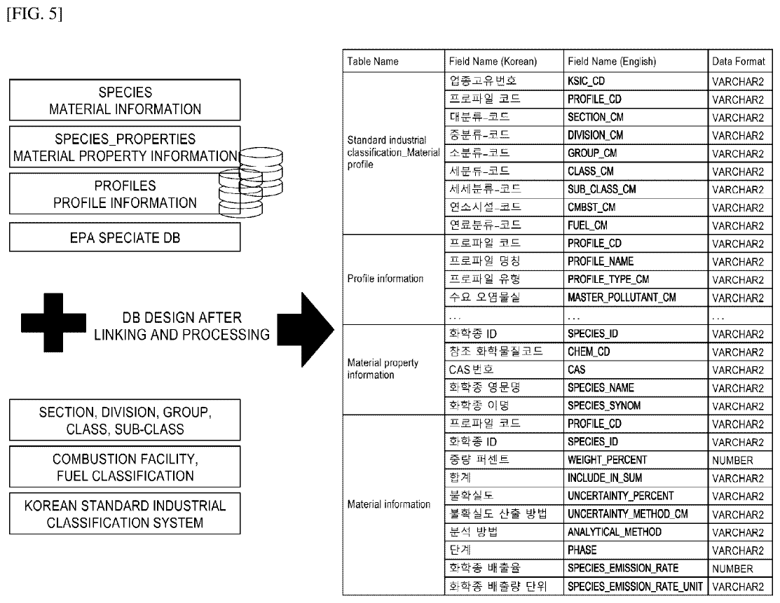

FIG. 5 is a view of an example of establishing a list of air pollutant sources and emissions.

Material information is separately stored by types of the companies and separately stored by emitted components.

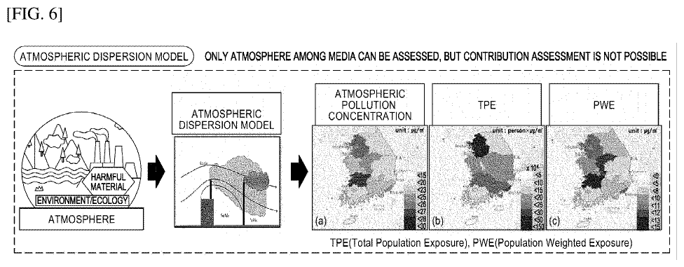

FIG. 6 is an exemplary view of an atmospheric dispersion model.

When exposure concentrations of hazardous substances for receptors are calculated based on the atmospheric dispersion model, the assessment may be performed based on pollutant concentrations and exposure populations.

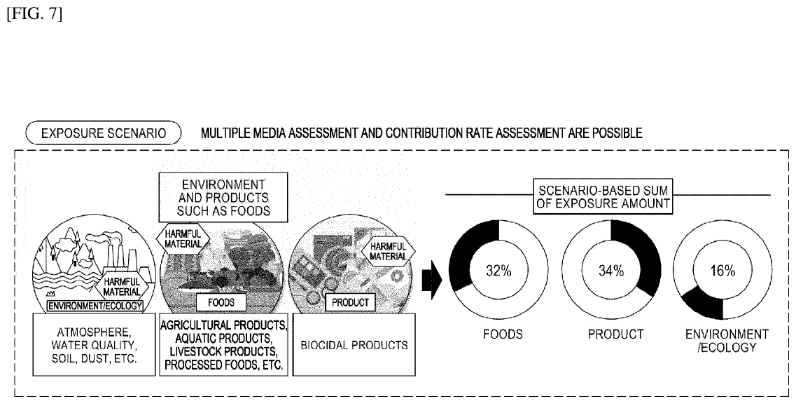

FIG. 7 is an exemplary view of an exposure scenario.

The assessment may be performed for exposure to environments including air, a water quality, soil, and dust, exposure to agricultural products, aquatic products, livestock products, and processed foods, and exposure to products.

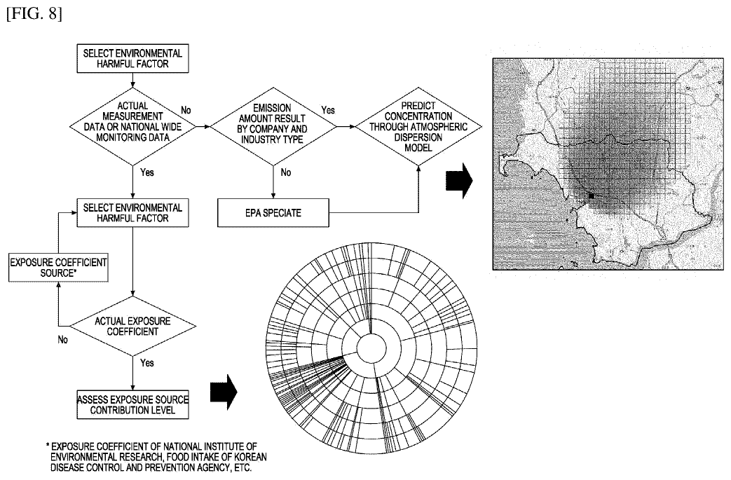

FIG. 8 is a flowchart of exposure assessment.

The exposure concentrations of hazardous substances are calculated and predicted using the actual measurement data and monitoring data, or by applying emission amounts classified by company and industry type to the atmospheric dispersion model, and the results, including the calculated concentrations displayed on a map and contribution levels for receptors, may also be presented.

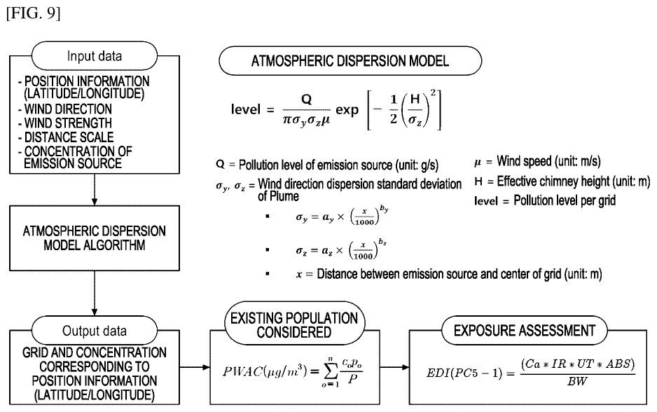

FIG. 9 is an exemplary view for calculating an atmospheric dispersion model, an existing population, and inhalation exposure assessment.

If information such as position information (latitude/longitude), the wind direction, the wind strength, a distance scale, and a concentration of an emission source is input, the grid and the concentration corresponding to the position information are calculated using the atmospheric dispersion model algorithm and the exposure assessment is performed in consideration of the existing population.

A modified embodiment, other than the above-described embodiments, will be described.

Here, the cumulative risk from exposure to two or more of several hazardous substances may be assessed.

The controller stores a reference safe concentration range for the exposure concentrations of hazardous substances when the exposure target is a receptor, and receives actual measurement data and monitoring data to calculate exposure concentrations for various receptors based on the atmospheric dispersion model. If the calculated exposure concentration exceeds the safe concentration range, the controller may send a warning text message to the terminal of a receptor in the corresponding region, advising them to refrain from going outside.

Here, even if the calculated exposure concentration does not exceed the safe concentration range, the exposure restriction time is stored, and corresponding restriction time information is transmitted to the terminal of the receptor in the corresponding region.

The integrated risk assessment may be performed by combining environmental exposure assessment with exposure assessment through the use of products such as foods. In this case, if the risk is found to be high, a warning may be transmitted to the emission source.

The controller stores information on multiple emission sources and performs analyses such as concentration analysis, correlation analysis, principal component analysis, factor analysis, and cluster analysis based on at least one of actual measurement data from residential environmental monitoring and actual measurement data from emission source monitoring received through the communication unit. Based on the analysis results and the stored information about the emission sources, the controller assesses the contribution level of each emission source.

When neither actual measurement data from residential environmental monitoring nor actual measurement data from emission source monitoring is received from the outside, the controller collects emissions from multiple emission sources and may predict the emission amounts of hazardous substances based on industry-specific emission data of the collected emissions.

The controller stores information on multiple emission sources, the emission amounts of hazardous substances from multiple emission sources, and the atmospheric dispersion model for the emission amounts of the hazardous substances. If neither actual measurement data from residential environmental monitoring nor actual measurement data from emission source monitoring is received from the outside, the controller collects at least one of actual measurement data or monitoring data for the emission amounts of hazardous substances from multiple emission sources and may predict the concentrations of hazardous substances for each emission source based on the atmospheric dispersion model.

The controller may control the display unit to present the concentrations and a ratios of the hazardous substances for each of various receptors and emission sources, based on a statistical technique.

The controller may display the assessed contribution level of each emission source with respect to each receptor.

Meteorological and topographical information between the emission source and the receptor are identified, and the movement path of hazardous substances from the emission source to the receptor is assessed using an artificial intelligence model. Based on this assessment, the proportion of hazardous substances transported to the receptor and the proportion filtered along the path may be calculated. By doing so, the exposure concentrations of hazardous substances at the receptor can be more accurately determined.

Here, if properties such as size, weight, scattering rate, moisture absorption rate, and emission temperature of hazardous substances emitted from each emission source are assessed and applied to the atmospheric dispersion model, the concentration of hazardous substances reaching the receptor can be more accurately predicted. The controller continuously collects actual measurement data from residential environmental monitoring, actual measurement data from emission source monitoring, the identified meteorological and topographical information between the emission source and the receptor, and the assessed physical and chemical properties of hazardous substances emitted from each emission source, and may update the atmospheric dispersion model based on these data.

The controller assesses the contribution level of each emission source, generates an improvement plan for each emission source, and transmits the improvement method to the corresponding company to improve its production and emission processes. The company may then transmit details of the improvements in the production and emission processes to the controller for storage. Thereafter, properties such as size, weight, scattering rate, moisture absorption rate, and emission temperature of hazardous substances emitted from the emission source are collected, and changes in the contribution level to the exposure concentrations of hazardous substances at the receptor resulting from the improvements may be identified. If it is confirmed that the exposure concentrations of hazardous substances at the receptor are reduced, continuous improvement may be induced.

Here, an improvement plan to reduce the exposure concentrations of hazardous substances at the receptor may be developed based on meteorological and topographical information between the emission source and the receptor. In other words, the improvement plan may include reducing hazardous substance concentrations for the receptor by implementing measures such as installing water fog parks between the emission source and the receptor, creating forests and parks, and installing wind turbines.

The atmospheric dispersion model may be updated using actual measurement data from environmental monitoring and from emission source monitoring between the emission source and the receptor. Such measurement data may be acquired by deploying a drone along the predicted movement path of pollutants between the emission source and the receptor, where the drone collects pollutants using a pollutant collection bag. Pollutant collection by the drone may be applied by accumulating data through repeated sampling under similar meteorological conditions.

Here, the drone collects pollutants along the path from the emission source to the receptor and updates the atmospheric dispersion model using data acquired by continuously identifying the movement path and distribution of the pollutants.

Here, the pollutant collection bag which is used for the drone may be a pollutant collection cloth which is broadly spread up, down, left, and right in the predicted pollutant movement path. Here, a balloon may be disposed for a long time to acquire the pollutants, rather than the drone. The collection cloth may be soaked in a solvent to collect organic hazardous substances. By doing so, the concentrations of various organic hazardous substances may be identified.

Hazardous air pollutants (HAPs) are analyzed in real time using a remote optical measurement vehicle deployed between the emission source and the receptor. Based on actual measurements, not only the concentrations of pollutants in the air but also the amounts of fine dust-forming substances emitted by specific pollutants and industrial complexes may be calculated. The atmospheric dispersion model may then be more accurately updated using the calculated emission amounts of hazardous substances.

According to the human risk assessment system 1 and the risk assessment method for environmental hazardous factors as described above, actual measurement data and monitoring data are applied to the atmospheric dispersion model to accurately calculate the exposure concentrations of hazardous substances for receptors in multiple regions. The risks of hazardous substances are then assessed, thereby enabling improvements to emission sources and identifying risky situations for receptors.

Further, even if actual measurement data are not available, the concentrations of hazardous substances can be predicted by identifying emissions classified by company and industry type.

Further, after accurately calculating the exposure concentrations of hazardous substances for receptors in multiple regions, the risks of hazardous substances may be assessed.

Further, the movement and dispersion of hazardous substances may be predicted, and these processes can be numerically represented to accurately calculate the exposure concentrations of hazardous substances for receptors in multiple regions.

Further, the impacts on receptors in the corresponding region are identified, and the concentrations of hazardous substances in the region can be easily recognized.

What is claimed is:

1. A human risk assessment system according to occurrence of environmental harmful factors, comprising:
a communication unit which receives at least one of actual measurement data and monitoring data from the outside; and
a controller that stores information on multiple emission sources, the emission amounts of hazardous substances from the emission sources, and an atmospheric dispersion model for the emission amounts. When at least one of actual measurement data or monitoring data on the emission amounts of hazardous substances from the emission sources is received from the communication unit, the controller calculates the exposure concentrations of hazardous substances for the receptors based on the atmospheric dispersion model and assesses the associated risks from the emission sources using the calculated exposure concentrations.

2. The human risk assessment system according to claim 1, wherein, when at least one of the actual measurement data and the monitoring data is not received from the communication unit, but emission amounts classified by company and industry type among multiple emission sources are received, the controller predicts the concentrations of hazardous substances for multiple emission sources based on the reception result and the atmospheric dispersion model.

3. The human risk assessment system according to claim 2, wherein the controller calculates a contribution level for various receptors based on the predicted concentrations of hazardous substances for multiple emission sources.

4. The human risk assessment system according to claim 1, wherein the actual measurement data and the monitoring data include position information comprising latitude and longitude of the emission source, wind direction, wind speed, distance scale, and concentrations of hazardous substances of the emission source.

5. The human risk assessment system according to claim 1, wherein the atmospheric dispersion model is formed by the following Equation:
$$level = \frac{Q}{π {σ}_{y} , {σ}_{x} μ} exp [ - \frac{1}{2} {( \frac{H}{{σ}_{z}} )}^{2} ] \\ Q = pollution level of emission source ( unit : g / s )$$
$${σ}_{y} , {σ}_{z} = wind direction dispersion standard deviation of plume \\ μ = wind speed ( unit : m / s ) \\ H = effective chimney height ( unit : m ) \\ level = pollution level per grid$$
$${σ}_{y} = {a}_{y} \times {( \frac{x}{1000} )}^{{b}_{y}} \\ {σ}_{z} = {a}_{z} \times {( \frac{x}{1000} )}^{{b}_{z}} \\ x = distance between emission source and center of grid ( unit : m ) .$$

6. The human risk assessment system according to claim 5, wherein the controller calculates a grid and the concentrations of hazardous substances corresponding to position information using the atmospheric dispersion model, and assesses the risks of hazardous substances from multiple emission sources based on the population of the calculated grid.

7. The human risk assessment system according to claim 6, further comprising a display unit configured to display the assessed risks of hazardous substances, wherein the controller controls the display unit to display the concentrations of hazardous substances in the calculated grid on a map.
